(19) United States
(12) Patent Application Publication
(10) Pub. No.: US 2024/0284558 A1
(43) Pub. Date: Aug. 22, 2024

(54) RADIO COMMUNICATION

(71) Applicant: Nordic Semiconductor ASA, Trondheim (NO)

(72) Inventors: Asbjørn SÆBØ, Trondheim (NO); Vinayak Kariappa CHETTIMADA, Hyderabad (IN); Emil GYDESEN, Aalborg (DK)

(73) Assignee: Nordic Semiconductor ASA, Trondheim (NO)

(21) Appl. No.: 18/442,455

(22) Filed: Feb. 15, 2024

(30) Foreign Application Priority Data
Feb. 17, 2023 (GB) 2302269.2

(51) Int. Cl. H04W 76/45

(52) U.S. Cl. CPC H04W 76/45

(57) ABSTRACT

A method of operating a radio communication system comprising a group of radio devices is provided. The method comprises a first radio device of the group broadcasting a radio signal in which data are encoded; radio devices of the group receiving the radio signal from the first radio device and decoding the data encoded therein; and a second radio device of the group broadcasting a radio signal in which data are encoded; coordinating at least one radio device of the group to transition from receiving the radio signal broadcast by the first radio device and decoding the data encoded therein to receiving the radio signal broadcast by the second radio device of the group and decoding the data encoded therein; and radio devices of the group receiving the radio signal from the second radio device and decoding the data encoded therein.

### CROSS REFERENCE TO RELATED APPLICATION

This application claims priority from Great Britain Application No. 2302269.2, filed Feb. 17, 2023, which application is incorporated herein by reference in its entirety.

### BACKGROUND OF THE INVENTION

The present invention relates to radio communication systems and methods of operating radio communication systems.

Many digital radio communication protocols are based on one-to-one connections (also known as unicast connections), in which two radio devices communicate only with each other. For instance, many of the Bluetooth communication protocols support unicast connections between central and peripheral devices.

Some radio communication protocols also facilitate one-to-many communications, in which one device broadcasts radio signals that can be detected by all suitable devices in range. For instance, version 5.2 of the Bluetooth protocol provides broadcast functionality, which can be used to broadcast data (e.g. audio data) from one device to many devices.

However, there is limited support in existing digital radio communication protocols for many-to-many communication, in which a group of several devices can all communicate with each other at the same time. This may be useful, for instance, to facilitate audio communications between groups of people. An improved approach may be desired.

### SUMMARY OF THE INVENTION

According to a first aspect of the present invention there is provided a method of operating a radio communication system comprising a group of radio devices, the method comprising:
a first radio device of the group broadcasting a radio signal in which data are encoded;
radio devices of the group receiving the radio signal from the first radio device and decoding the data encoded therein;
a second radio device of the group broadcasting a radio signal in which data are encoded;
coordinating at least one radio device of the group to transition from receiving the radio signal broadcast by the first radio device and decoding the data encoded therein to receiving the radio signal broadcast by the second radio device of the group and decoding the data encoded therein; and
radio devices of the group receiving the radio signal from the second radio device and decoding the data encoded therein.

According to a second aspect of the present invention there is provided a radio communication system comprising a group of radio devices, the group of radio devices comprising:
a first radio device arranged to broadcast a radio signal in which data are encoded;
a second radio device arranged to broadcast a radio signal in which data are encoded; and
a plurality of radio devices operable to receive the radio signal from the first or second radio device and to decode the data encoded therein;
   wherein the communication system is arranged to coordinate at least one radio device of the group to transition from receiving the radio signal broadcast by the first radio device and decoding the data encoded therein to receiving the radio signal broadcast by the second radio device of the group and decoding the data encoded therein

It will be recognised by those skilled in the art that, by coordinating a transition from the broadcast of the first radio device to the broadcast of the second radio device, robust and efficient many-to-many communication amongst the group of radio devices may be achieved without needing to establish numerous and potentially-complex two-way communications between each device in the group. Because the transition is actively coordinated (i.e. rather than each radio device being left to determine what broadcast to receive), the group of radio devices can achieve reliable many-to-many communication. The first and second radio devices can be confident that their broadcasts will be properly received by other devices of the group that are in range, and receiving devices that are in range can be confident that they will receive each broadcast in the many-to-many communication. In other words, the first radio device can be confident that, before the transition, its broadcast will be received by the other radio devices of the group, and the second radio device can be confident that, after the transition, its broadcast will be received by the other radio devices of the group.

Because the radio signals are broadcast (i.e. as one-way, one-to-many transmissions), they are not reliant on acknowledgment signals from the devices receiving the broadcast. As such, this approach may be conveniently scalable to large groups of radio devices including large numbers of broadcasting devices without requiring substantial increases in power or processing resources of any individual device.

The radio communication system enables many-to-many communication and thus the group of radio devices comprises at least three radio devices (i.e. the first and second radio device and at least one other radio device). Two or more radio devices receive the radio signal from each of the first and second devices. The second radio device may be one of the radio devices to receive the radio signal broadcast by the first radio device. Similarly, after the transition, the first radio device may be one of the radio devices that receive the radio signal broadcast by the second radio device. In other words, the first and/or second radio device may be included in the plurality of radio devices operable to receive the radio signal from the first or second radio device. The first radio device may stop broadcasting the radio signal as part of or after the transition.

The invention may also extend to larger groups of radio devices. In a set of embodiments, the group of radio devices comprises four or more radio devices, five or more radio devices, ten or more radio devices or even twenty or more radio devices.

In some embodiments, only the first and second radio device broadcast radio signals, with the other radio devices in the group acting as receivers of the broadcasts. For instance, radio devices of the group may alternate between receiving a broadcast from the first radio device and a broadcast from the second radio device (with suitably coordinated transitions).

However, the approach disclosed herein can easily be scaled to include further broadcasting radio devices, by coordinating relevant transitions when required. In a set of embodiments, the method further comprises:
a third radio device of the group broadcasting a radio signal in which data are encoded;
coordinating at least one radio device of the group to transition from receiving the radio signal broadcast by the second radio device and decoding the data encoded therein to receiving the radio signal broadcast by the third radio device of the group and decoding the data encoded therein; and
radio devices of the group receiving the radio signal from the third radio device and decoding said data.

In some embodiments, every radio device of the group may be operable to broadcast a radio signal in which data are encoded. The method may comprise coordinating radio devices of the group to transition between receiving different radio signals broadcast by each radio device of the group (e.g. with each device broadcasting in turn, or in a dynamic order based on communication requirements)

The data encoded in the radio signals may be any data useful in many-to-many communications. In a set of embodiments the data encoded in one or more of the radio signals are audio data (e.g. captured by one or more of the radio devices). One or more of the radio devices may comprise a microphone and/or an audio interface for capturing the audio data. Captured audio data may be broadcast in real-time or near real-time.

One or more of the radio devices may facilitate play back of audio data (e.g. received from the first and/or second radio devices), e.g. by decoding and processing the audio data into a suitable format. One or more of the radio devices may comprise a loudspeaker and/or an audio interface for playing back audio. Audio data may be played back in real-time or near real-time.

It may be particularly useful to facilitate many-to-many communication of audio data because many human interactions involve oral communication in groups. For instance, the first and/or second radio device of the group may broadcast in real-time audio data of a person talking (e.g. live audio captured with a microphone), and one or more radio devices of the group may play the audio data back in real-time (e.g. through a loudspeaker).

Preferably, the first and second radio device coordinate their broadcasts to avoid or minimise time overlap between their radio signals. In a set of embodiments, there is minimal or no time gap overlap between the radio signal broadcast by the first radio device and the radio signal broadcast by the second radio device. The first radio device may stop broadcasting the radio signal before or simultaneously with the second radio device starting to broadcast its radio signal. Avoiding time overlaps may allow the many-to-many communication to be achieved whilst utilising only a limited amount of radio capacity. Moreover, this principle of avoiding time overlaps between broadcasts may be extended to large numbers of broadcasters, allowing a large number of radio devices to carry out many-to-many communication using only a small amount of radio capacity.

In a set of embodiments, the first radio device of the group broadcasts the radio signal for 0.1 s or more, 1 s or more or 10 s or more. Additionally or alternatively, the second radio device of the group broadcasts the radio signal for 0.1 s or more, 1 s or more or 10 s or more.

The approach disclosed herein may be applied to radio devices broadcasting using any suitable digital radio communication protocol, i.e. in which the data are encoded using a digital modulation technique such as phase-shift keying or frequency-shift keying. In a set of embodiments, the data are encoded using Gaussian frequency-shift keying (GFSK) or differential encoded quaternary phase-shift keying (DQPSK). In a set of embodiments, the radio signals are frequency hopping spread-spectrum (FHSS) signals.

The data may be broadcast in packets. The radio devices may be Bluetooth devices (e.g. Bluetooth Low Energy (BLE) devices). The radio devices may be arranged to communicate using Bluetooth Isochronous Channels (ISOC). In a set of embodiments, the radio signals broadcast by the first and second radio devices comprise Broadcast Isochronous Streams. The radio devices may operate according to a Bluetooth LE Audio protocol. One or more of the radio devices may be radio transceiver devices (i.e. operable to transmit and receive radio signals).

Coordinating the transition from receiving the radio signal broadcast by the first radio device to receiving the radio signal broadcast by the second radio device may comprise radio devices of the group following a predetermined broadcast schedule. For instance, the group of radio devices may agree in advance a broadcast schedule in which the first and second radio devices (and possibly further devices) have allocated broadcast timings, and a radio device of the group then transitions from receiving the radio signal broadcast by the first radio device to receiving the radio signal broadcast by the second radio device of the group at the time indicated by the schedule. The schedule may comprise a fixed and equal broadcast duration for each broadcaster (i.e. the first, second and any further broadcasting radio devices). Alternatively, the schedule may comprise a repeating pattern of broadcast durations for some or all broadcasters and/or entirely bespoke broadcast durations for some or all broadcasters (e.g. timed for certain expected events).

The schedule may be based on time. For instance, the schedule may set out one or more timings (e.g. a start time, a duration and/or an end time) for the broadcasting of radio signals by the first and/or second radio device (and/or, in relevant embodiments, further broadcasting devices). However, in some embodiments, additionally or alternatively, the broadcast schedule may use other parameters to coordinate the broadcasts, such as a quantity of data broadcast or a number of packets broadcast. For instance, the broadcast schedule may indicate to transition to the broadcast of the second device once the first device has broadcast a set number of packets.

Agreeing a broadcast schedule in advance may be a particularly robust mechanism for performing many-to-many communication, because even if a broadcaster fails or moves out of range, communication can simply continue with the next broadcaster at its allocated point in the schedule. However, a predetermined broadcast schedule may not be appropriate for all many-to-many communications. For instance, in some applications it may not be known in advance when or how long a broadcast needs to be. For instance, the radio communication system may be used for oral communication between multiple people, in which each person may wish to talk at unpredictable times and for an unpredictable amount of time.

In a set of embodiments, coordinating the transition from the radio signal broadcast by the first radio device to receiving the radio signal broadcast by the second radio device comprises radio devices of the group receiving a transition signal. The transition signal may comprise an instruction to switch to the radio signal broadcast by the second radio device. The transition signal may include an indication of when the transition is to occur and/or one or more broadcast parameters for receiving the radio signal broadcast by the second radio device and/or information for obtaining one or more broadcast parameters for receiving the radio signal broadcast by the second radio device.

In a set of embodiments, the transition signal is issued by the first radio device, e.g. as part of the radio signal broadcast by the first radio device. For instance, the first radio device may decide unilaterally that the second radio device should take over broadcasting and issue the transition signal accordingly at or near the end of its broadcast. Additionally or alternatively, the first radio device may issue the transition signal in response to an external trigger such as a broadcast request from the second radio device (e.g. a user pressing a “push-to-talk” button).

In a set of embodiments, the transition signal is issued by the second radio device. For instance, the second radio device may decide unilaterally to take over broadcasting and issue the transition signal accordingly. For instance, a user of the second radio device may trigger the issuance of the transition signal by pressing a “push-to-talk” button. Additionally or alternatively, the second radio device may issue the transition signal in response to an external trigger, such as a request to take over broadcasting from the first radio device. In some embodiments, the second radio device issues the transition signal in response to detecting a loss of the radio signal broadcast by the first radio device (e.g. because the first radio device has moved out of range). Transitioning to the radio signal broadcast by the second radio device in response to the loss of the radio signal broadcast by the first radio device may improve the robustness of the communication system.

The transition signal may comprise an advertising signal (e.g. comprising one or more BLE Extended Advertising packets), indicating one or more parameters for receiving the radio signal broadcast by the second radio device (e.g. a broadcast ID and/or broadcast timing information). For instance, the second radio device may issue the transition signal as an advertising signal. The transition signal may include Periodic Advertising Sync Transfer (PAST) data, or PAST-like data parameters. Alternatively, the transition signal may include an instruction to scan for a separate advertising signal indicating one or more parameters for receiving radio signal broadcast by the second radio device. For instance, the first radio device may issue a transition signal that instructs radio devices to scan for an advertising signal from the second radio device.

In some embodiments, the first radio device may issue a transition signal comprising information received from the second radio device. For instance, the second radio device may be arranged to send its broadcast parameters (e.g. PAST or PAST-like data) to the first radio device in a return packet to the first radio device, and then the first radio device may issue the transition signal comprising said parameters. Other radio devices can then transition to the broadcast of the second radio device using the information contained in the transition signal from the first radio device.

In a set of embodiments, coordinating a radio device of the group to transition from receiving the radio signal broadcast by the first radio device to receiving the radio signal broadcast by the second radio device of the group is achieved by the first and second radio devices broadcasting their radio signals in such a way to avoid the need for explicit transition instruction.

In a set of embodiments, the first and second radio devices broadcast radio signals using at least one broadcast parameter associated with a pseudo radio device. In other words, the first and second radio devices are arranged to impersonate a common pseudo radio device when broadcasting radio signals. For instance, the first and second radio devices may broadcast their radio signals using a broadcast ID and/or broadcast timings associated with a pseudo radio device. In such embodiments, radio devices of the group are configured to receive radio signals broadcast by the pseudo radio device (i.e. that appear to be broadcast by the pseudo radio device), e.g. the radio devices may use one or more settings (e.g. broadcast ID and/or broadcast timings) associated with the pseudo radio device.

Radio devices of the group may thus be able to transition from receiving the radio signal broadcast by the first radio device to that broadcast by the second radio device without needing to change reception settings (despite the fact that they are, in reality, transitioning between two different broadcasts by the two different devices). This may facilitate a smooth transition and improve reliability, because the group successfully transitioning from the broadcast of the first radio device to the broadcast of the second radio device of the group does not rely on a potentially large number of receiving radio devices correctly updating their reception settings at the right time.

This approach may conveniently be extended to the broadcasts of further devices, i.e. wherein one or more further radio devices broadcast radio signals using at least one broadcast parameter associated with a pseudo radio device. Many-to-many communication between a large number of radio devices may thus be achieved with little or no active coordination required for receiving devices.

In embodiments utilising a pseudo radio device, it may be useful for the first and second radio devices (and any further broadcasting radio devices) to coordinate their broadcasts, e.g. to avoid interfering with the other's broadcast. This coordination may be achieved using a predetermined broadcast schedule or a transition signal issued by the first and/or second radio device as explained above.

According to a third aspect the invention extends to a method of operating a radio communication system comprising a group of radio devices, the method comprising:
a first radio device of the group broadcasting a radio signal in which data are encoded, said broadcasting using at least one broadcast parameter associated with a pseudo radio device;
radio devices of the group using at least one broadcast parameter associated with the pseudo radio device to receive the radio signal from the first radio device and decode the data encoded therein;
a second radio device of the group broadcasting a radio signal in which data are encoded, said broadcasting using the at least one broadcast parameter associated with the pseudo radio device; and
radio devices of the group using the at least one broadcast parameter associated with the pseudo radio device to receive the radio signal from the second radio device and decode the data encoded therein.

According to a fourth aspect the invention extends to a radio communication system comprising a group of radio devices, the group of radio devices comprising:
a first radio device arranged to broadcast a radio signal in which data are encoded, said broadcast using at least one broadcast parameter associated with a pseudo radio device;
a second radio device arranged to broadcast a radio signal in which data are encoded, said broadcast using at least one broadcast parameter associated with the pseudo radio device; and
a plurality of radio devices operable to use the at least one broadcast parameter associated with the pseudo radio device to receive the radio signal from the first and second radio device and decode the data encoded therein.

It will be appreciated that each and all of the features described above regarding coordinating radio devices to transition from the radio signal broadcast by the first radio device to that broadcast by the second radio device are also applicable to subsequent transitions (e.g. from a radio signal broadcast by the second radio device to a radio signal broadcast by a third radio device, and/or from any further broadcast to a subsequent broadcast).

The invention extends to a radio communication system comprising a group of radio devices and arranged to perform the method disclosed herein.

The invention also extends to software that, when executed by a radio communication system comprising a group of radio devices, causes said radio communication system to perform the method disclosed herein. One or more radio devices of the communication system may comprise a memory storing part or all of said software. One or more radio devices of the communication system may comprise a processor arranged to execute part or all of said software.

Moreover, features of any aspect or embodiment described herein may, wherever appropriate, be applied to any other aspect or embodiment described herein. Where reference is made to different embodiments, it should be understood that these are not necessarily distinct but may overlap. It will be appreciated that all of the preferred features of the method according to the first aspect described above may also apply to the other aspects of the invention.

### BRIEF DESCRIPTION OF THE DRAWINGS

One or more non-limiting examples will now be described, by way of example only, and with reference to the accompanying figures in which:

FIG. 1 shows a radio communication system operated according to embodiments of the invention at a first time; and

FIG. 2 shows the radio communication system of FIG. 1 at a subsequent second time;

FIG. 3 shows a radio communication system operated according to another embodiment of the invention at a first time; and

FIG. 4 shows the radio communication system of FIG. 3 at a subsequent second time.

### DETAILED DESCRIPTION

A radio communication system 100 comprises a group of radio devices 102A, 102B, 102C, 102D. The radio devices 102A-102D communicate using Bluetooth Isochronous Channels (ISOC) and specifically according to a Bluetooth LE Audio protocol (although other, non-audio implementations are also possible). The first radio device 102A comprises a microphone 104A, a loudspeaker 106A (e.g. as part of a pair of headphones), a processor 108A, a memory 110A, a radio front-end portion 112A and an antenna 114A. Although not illustrated, each of the other radio devices 102B-102D also comprises the same components.

The radio communication system 100 provides many-to-many communication between the group of radio devices 102A-102D. The radio communication system 100 may comprise a conference call system, with each radio device 102A-102D used by a different user to speak and listen to speech from the other users. Alternatively, the radio communication system 100 may comprise a workplace communication system, where some of the radio devices 102A-102D are used by employees for communication and at least one of the radio devices 102A-102D is a warning device for issuing audible warnings to employees' devices.

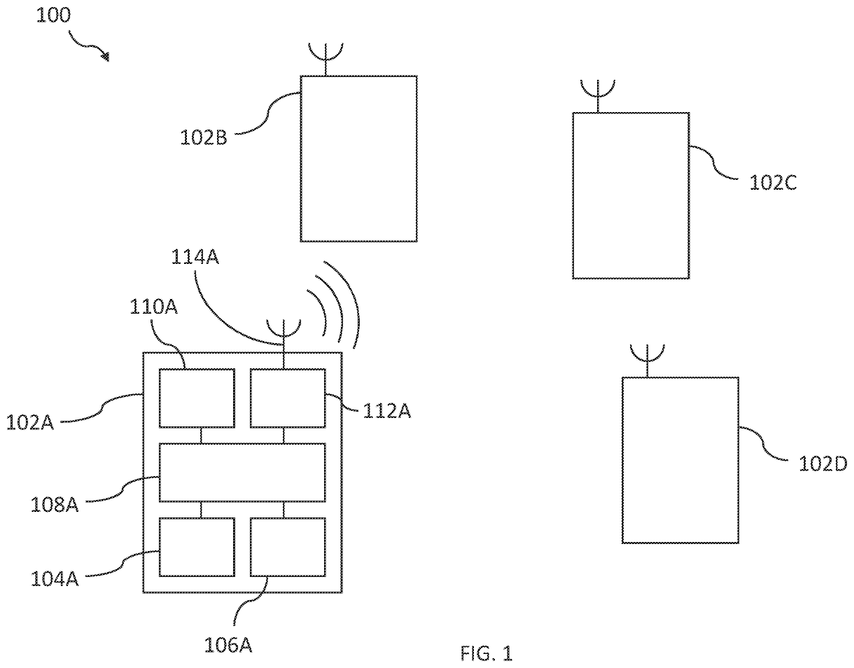

At a first time, illustrated in FIG. 1, the first radio device 102A captures sound with the microphone 104A, processes the captured sound with the processor 108A to produce a series of data packets in which the sound is encoded, and broadcasts these data packets using the radio front-end portion 112A and the antenna 114A. The data packets are broadcast as a Broadcast Isochronous Stream (BIS), receivable by any suitable device in range. The first radio device 102A broadcasts accompanying periodic advertising packets to advertise the presence and parameters (e.g. broadcast ID, timing) of the BIS. Each of the radio devices 102B-102D receives the BIS based on the advertising data, decodes the data packets and plays back the underlying audio with their loudspeakers.

To facilitate many-to-many communication, each of the radio devices 102A-102D broadcasts a BIS at a different time. To coordinate the radio devices 102A-102D properly receiving each BIS, the radio devices 102A-102D agree in advance a broadcast schedule, which indicates when and for how long each device will broadcast.

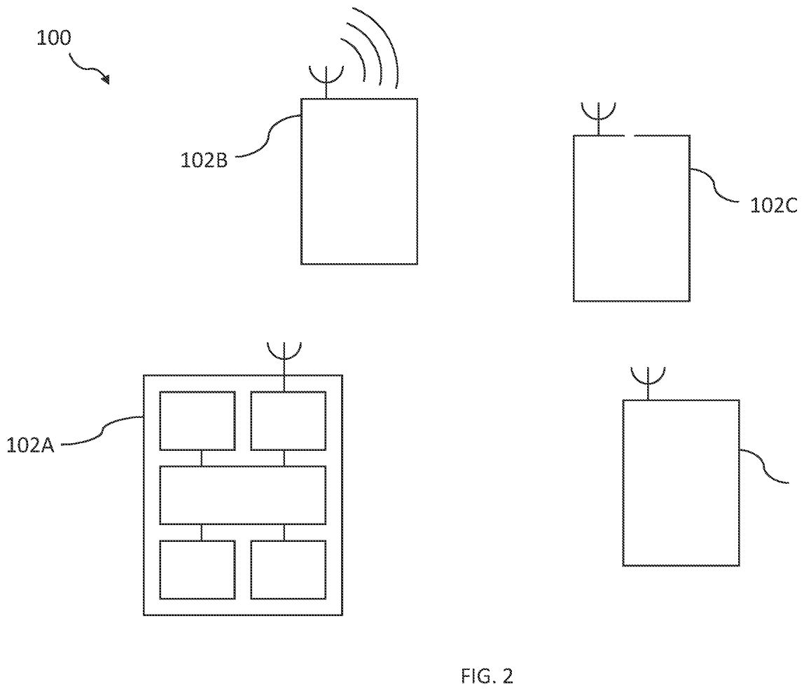

Thus, at a predetermined transition time set out in the pre-agreed broadcast schedule, the first radio device 102A stops broadcasting audio, and the second radio device 102B begins to broadcast audio captured with its microphone. Again, the second radio device 102B encodes the audio into data packets and broadcasts these as a Broadcast Isochronous Stream (BIS) with accompanying periodic advertising packets. The other devices 102A, 102C, 102D detect the new BIS and receive, decode and play back the audio from the second radio device 102B. This is shown in FIG. 2.

This process repeats, with each of the radio devices 102A-102D broadcasting in turn and the other devices 102A-102D of the group receiving said broadcasts according to the broadcast schedule. The radio communication system 100 thus enables many-to-many communication, with each radio device 102A-102D able to broadcast to each of the other radio devices 102A-102D.

In another embodiment, additionally or alternatively to using a broadcast schedule, the radio communication system 100 uses transition signals to coordinate the radio devices 102A-102D properly receiving each BIS. For instance, when the second radio device 102B wishes to broadcast (e.g. just prior to the second time shown in FIG. 2), the second radio device 102B may issue an advertising packet comprising a transition signal, which indicates to the other radio devices of the group 102A, 102C, 102D that the second radio device 102B is about to start a BIS. In response, the first radio device 102A stops its own BIS and the radio devices 102A, 102C, 102D configure themselves to receive the BIS from the second radio device 102B. This process repeats as and when each of the radio devices 102A-102D wishes to broadcast.

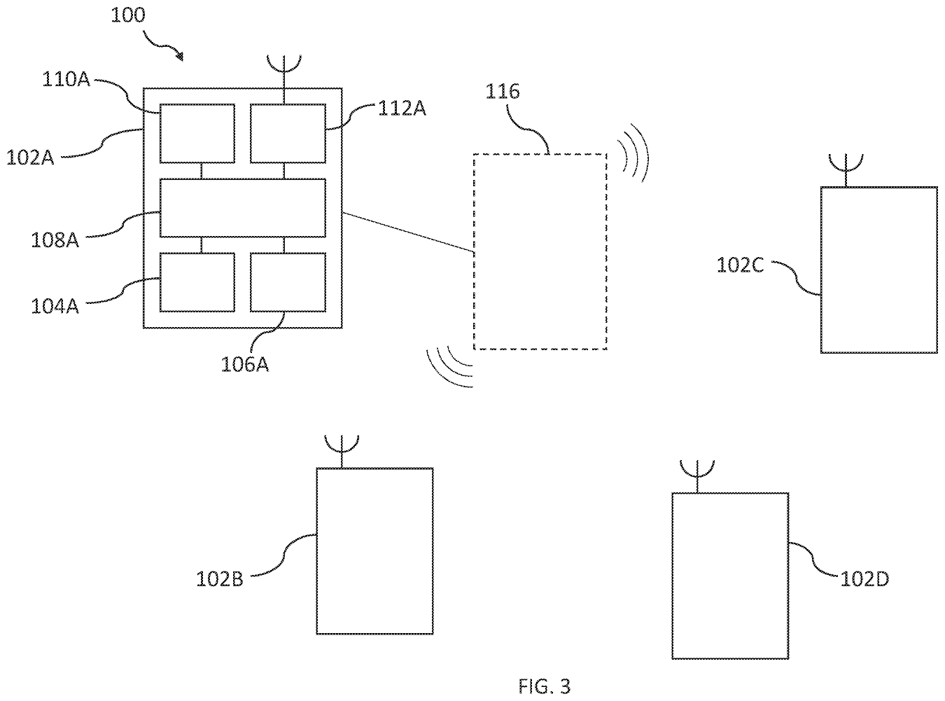

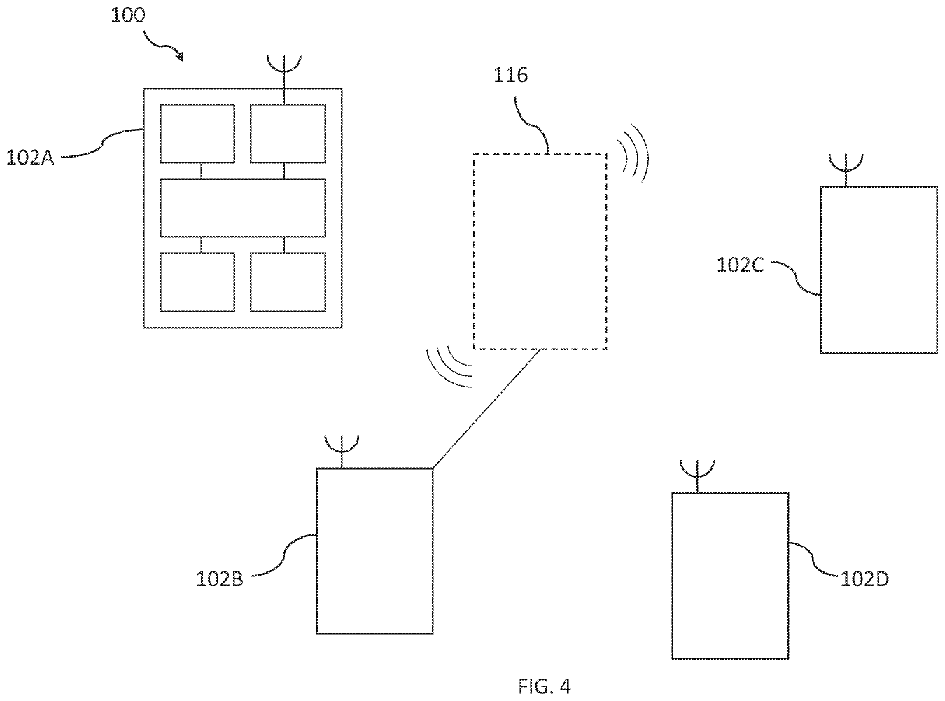

In another embodiment, the radio communication system 100 is operated as described below, with reference to FIGS. 3 and 4. In this embodiment, the radio devices 102A-102D again communicate using Bluetooth LE Audio.

At a first time, illustrated in FIG. 3, the first radio device 102A captures sound with the microphone 104A, processes the captured sound with the processor 108A to produce a series of data packets in which the sound is encoded, and broadcasts these data packets using the radio front-end portion 112A and the antenna 114A. The data packets are broadcast as a Broadcast Isochronous Stream (BIS), receivable by any suitable device in range.

In this embodiment, however, the first radio device 102A broadcasts the BIS using broadcast parameters (e.g. broadcast ID, timing) associated with a pseudo radio device 116. In other words, the first radio device 102A impersonates the pseudo device 116 when broadcasting the BIS. The first radio device 102A transmits periodic advertising packets which indicate the broadcast parameters of the pseudo device 116.

Each of the radio devices 102B-102D receives the BIS based on the advertising data, decodes the data packets and plays back the underlying audio with their loudspeakers. To each radio device 102B-102D it appears as though they are receiving the broadcast from the pseudo device 116.

At a second time (e.g. following a broadcast schedule), the first radio device 102A stops broadcasting audio, and the second device 102B begins to broadcast audio captured with its microphone. This is shown in FIG. 4.

Again, the second radio device 102B encodes the audio into data packets and broadcasts these as a Broadcast Isochronous Stream (BIS). The second radio device 102B broadcasts the BIS using the broadcast parameters associated with a pseudo radio device 116, i.e. the second radio device 102B also impersonates the pseudo device 116 to broadcast the BIS.

The other devices 102C, 102D are thus coordinated to receive the BIS from the second radio device 102B without needing to make any adjustments to their reception settings. The broadcast from the second radio device 102B simply appears to the third and fourth devices 102C, 102D to be a continuation of the original BIS from the pseudo device 116. The first radio device 102A also begins to receive the BIS from the second radio device 102B by scanning for and receiving the BIS from the pseudo device (i.e. it does not necessarily need to know which device has taken over broadcasting).

The use of the pseudo device 116 may simplify operation of the radio communication system 100 and facilitate smooth transitions between the broadcasts from the first radio device 102A to the second radio device 102B. This process repeats for broadcasts by the third and fourth radio devices 102C, 102D, with each impersonating the pseudo device 116 when broadcasting.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of operating a radio communication system comprising a group of radio devices, the method comprising:
a first radio device of the group broadcasting a radio signal in which data are encoded;
radio devices of the group receiving the radio signal from the first radio device and decoding the data encoded therein;
a second radio device of the group broadcasting a radio signal in which data are encoded;
coordinating at least one radio device of the group to transition from receiving the radio signal broadcast by the first radio device and decoding the data encoded therein to receiving the radio signal broadcast by the second radio device of the group and decoding the data encoded therein; and
radio devices of the group receiving the radio signal from the second radio device and decoding the data encoded therein.

2. The method of claim 1, further comprising:
a third radio device of the group broadcasting a radio signal in which data are encoded;
coordinating at least one radio device of the group to transition from receiving the radio signal broadcast by the second radio device and decoding the data encoded therein to receiving the radio signal broadcast by the third radio device of the group and decoding the data encoded therein; and
radio devices of the group receiving the radio signal from the third radio device and decoding said data.

3. The method of claim 1, wherein the data encoded in one or more of the radio signals are audio data.

4. The method of claim 3, wherein one or more of the radio devices comprises a microphone and/or an audio interface for capturing the audio data.

5. The method of claim 3, wherein one or more of the radio devices facilitates play back of the audio data.

6. The method of claim 1, comprising the first and/or second radio device of the group broadcasting in real-time audio data of a person talking and one or more radio devices of the group playing the audio data back in real-time.

7. The method of claim 1, wherein there is minimal or no time gap overlap between the radio signal broadcast by the first radio device and the radio signal broadcast by the second radio device.

8. The method of claim 1, wherein the radio devices are Bluetooth devices such as Bluetooth Low Energy devices.

9. The method of claim 1, wherein the radio signals broadcast by the first and second radio devices comprise Broadcast Isochronous Streams.

10. The method of claim 1, wherein coordinating the transition from receiving the radio signal broadcast by the first radio device to receiving the radio signal broadcast by the second radio device comprises the radio devices of the group following a predetermined broadcast schedule.

11. The method of claim 1, wherein coordinating the transition from the radio signal broadcast by the first radio device to receiving the radio signal broadcast by the second radio device comprises radio devices of the group receiving a transition signal.

12. The method of claim 11, wherein the transition signal is issued by the first radio device.

13. The method of claim 11, wherein the transition signal is issued by the second radio device.

14. The method of claim 13, wherein the transition signal is issued in response to a user of the second radio device pressing a “push-to-talk” button.

15. The method of claim 11, wherein the transition signal comprises an advertising signal indicating one or more parameters for receiving the radio signal broadcast by the second radio device.

16. The method of claim 1, wherein the first and second radio devices broadcast radio signals using at least one broadcast parameter associated with a pseudo radio device and radio devices of the group are configured to receive radio signals broadcast by the pseudo radio device.

17. A radio communication system comprising a group of radio devices, the group of radio devices comprising:
a first radio device arranged to broadcast a radio signal in which data are encoded;
a second radio device arranged to broadcast a radio signal in which data are encoded; and
a plurality of radio devices operable to receive the radio signal from the first or second radio device and to decode the data encoded therein;
wherein the communication system is arranged to coordinate at least one radio device of the group to transition from receiving the radio signal broadcast by the first radio device and decoding the data encoded therein to receiving the radio signal broadcast by the second radio device of the group and decoding the data encoded therein.

18. A radio communication system comprising a group of radio devices, the group of radio devices comprising:
a first radio device arranged to broadcast a radio signal in which data are encoded, said broadcast using at least one broadcast parameter associated with a pseudo radio device;
a second radio device arranged to broadcast a radio signal in which data are encoded, said broadcast using at least one broadcast parameter associated with the pseudo radio device; and
a plurality of radio devices operable to use the at least one broadcast parameter associated with the pseudo radio device to receive the radio signal from the first and second radio device and decode the data encoded therein.
